(19) United States
(12) Patent Application Publication
(10) Pub. No.: US 2025/0097824 A1
(43) Pub. Date: Mar. 20, 2025

(54) SYSTEMS AND METHODS FOR DETERMINING AN ALLOWED NETWORK SLICE SELECTION ASSISTANCE INFORMATION BASED ON LOCATION INFORMATION AND TIME INFORMATION

(71) Applicant: Verizon Patent and Licensing Inc., Basking Ridge, NJ (US)

(72) Inventors: Sudhakar Reddy PATIL, Flower Mound, TX (US); Lixia YAN, Basking Ridge, NJ (US); Helen Osias EGLIP, Sammamish, WA (US); Violeta CAKULEV, Milburn, NJ (US); Raquel MORERA SEMPERE, Weehawken, NJ (US)

(73) Assignee: Verizon Patent and Licensing Inc., Basking Ridge, NJ (US)

(21) Appl. No.: 18/470,062

(22) Filed: Sep. 19, 2023

(51) Int. Cl. H04W 48/08; H04W 48/18; H04W 64/00

(52) U.S. Cl. CPC H04W 48/08; H04W 48/18; H04W 64/00

(57) ABSTRACT

In some implementations, an access and mobility management function (AMF) may receive subscribed network slice selection assistance information (NSSAI) that indicates location information associated with a slice and time information associated with the slice. The AMF may determine an allowed NSSAI based on one or more of the location information, the time information, a static policy, or a dynamic policy. A access and mobility policy control function (AM-PCF) may create the dynamic policy to determine a location and a time at which the subscribed NSSAI may be used. The AMF may transmit, to a user equipment (UE), an indication of the allowed NSSAI.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications.

### BRIEF DESCRIPTION OF THE DRAWINGS

FIG. 1 is a diagram of an example associated with subscribed network slice selection assistance information (NSSAI).

FIG. 2 is a diagram of an example associated with determining an allowed NSSAI based on location information and time information.

FIG. 3 is a diagram of an example associated with determining an allowed NSSAI based on location information and time information.

FIG. 4 is a diagram of an example associated with determining an allowed NSSAI based on location information and time information.

FIG. 5 is a diagram of an example environment in which systems and/or methods described herein may be implemented.

FIG. 6 is a diagram of example components of one or more devices of FIG. 5.

FIG. 7 is a flowchart of an example process associated with determining an allowed NSSAI based on location information and time information.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) route selection policy (URSP) may be a policy used by a UE for routing outgoing traffic. Traffic may be routed to an established protocol data unit (PDU) session in accordance with the URSP. Traffic may be offloaded to a non-Third Generation Partnership Project (non-3GPP) access outside a PDU session in accordance with the URSP. Traffic may trigger an establishment of a new PDU session in accordance with the URSP. The URSP may include a set of one or more URSP rules. URSP rules may be defined for a Fifth Generation (5G) core network (CN). URSP rules may also be used in an Evolved Packet System (EPS).

A policy control function (PCF) may transmit, to an access and mobility management function (AMF), a URSP. The URSP may include URSP rules related to traffic routing (or data routing). The AMF may forward the URSP to a radio access network (RAN). The RAN may forward the URSP to the UE. The UE may use the URSP for routing outgoing traffic.

A URSP rule may indicate a route selection descriptor, which may be associated with a plurality of route selection descriptor parameters. The plurality of route selection descriptor parameters may be defined for the URSP rule. A route selection descriptor parameter may be associated with a mapped EPS parameter, which may or may not be the same as the route selection descriptor parameter. The route selection descriptor parameter may include a route selection descriptor precedence, which may determine an order in which route selection descriptors are to be applied. The route selection descriptor parameter may include a session and service continuity (SSC) mode selection, which may correspond to one single value of SSC mode. The route selection descriptor parameter may include a network slice selection, which may correspond to a single value or a list of values of single network slice selection assistance information (S-NSSAI(s)). The route selection descriptor parameter may include a DNN selection, which may correspond to a single value or a list of values of DNN(s). The route selection descriptor parameter may include a PDU session type selection, which may correspond to one single value of PDU session type. The route selection descriptor parameter may include a non-seamless offload indication, which may indicate when traffic of a matching application is to be offloaded to non-3GPP access outside of a PDU session. The route selection descriptor parameter may include an access type preference, which may indicate a preferred access type (e.g., 3GPP or non-3GPP) when the UE establishes a PDU session for the matching application. The route selection descriptor parameter may include a multi-access preference, which may indicate that a PDU session should be established as a multi-access PDU session, using both 3GPP access and non-3GPP access.

The route selection descriptor parameter may include a time window, which may correspond to a time window during which matching traffic is allowed. The route selection descriptor parameter may include location criteria, which may correspond to a UE location where matching traffic is allowed. Thus, the route selection descriptor in the URSP rule may contain information on the location/time where/when the URSP rule may be used. For example, the URSP rule may be applicable only to a specific location or time of day.

A network slice selection assistance information (NSSAI) may indicate a list of slice identifiers. While the URSP rule has the time and location information, an allowed NSSAI may be computed as an intersection between a configured NSSAI (or subscribed NSSAI) and a supported NSSAI, regardless of the time and location at which the UE is allowed to use a corresponding slice. The allowed NSSAI may correspond to a list of slices that the UE is allowed to use in a registration area. The allowed NSSAI may be provided by a network to the UE. The UE may only connect to slices that are part of the allowed NSSAI. The configured NSSAI may correspond to a list of slices (or NSSAIs) subscribed to by the UE. The configured NSSAI may correspond to a list of slices (or NSSAIs) supported by the network in the registration area.

For each UE, the allowed NSSAI may be computed by a network as the intersection between the configured NSSAI and the supported NSSAI, regardless of the time and location at which the UE is allowed to use the corresponding slice. For example, for slice 1, when a user subscribes to slice 1 and a gNB supports slice 1, an allowed NSSAI may contain slice 1. A route selection descriptor for slice 1 in a URSP may indicate that slice 1 should only be used at a given period of time or location, which may pose a security threat. For example, the UE may be considered as an untrusted entity (e.g., the UE may be rogue), and/or a UE implementation may not be reliable for this type of route selection descriptor. In networks with relatively large coverage areas and unreliable support of specific network slices, the route selection descriptor parameter containing a location and a time duration (e.g., a start time and a stop time) may be relatively large in nature (e.g., a position may be associated with a cell-level granularity).

For the UE to access a slice, the UE may have URSP rules to grant access to the slice (either as a default URSP rule or as a non-default URSP rule), and the slice may be part of the allowed NSSAI. The AMF may compute the allowed NSSAI based on local information, a requested NSSAI, and/or the subscribed NSSAI. However, the allowed NSSAI may not be influenced by policies. While the URSP rules may contain location criteria and a time window, which may provide an indication to the UE regarding an availability of the slice, such information is not made available at the PCF for use when generating the URSP rules. As a result, the URSP rules may be generated without the time and location information, which may lead to slices only being available at times and/or locations that conflict with the URSP rules, which may degrade an overall network performance.

In some implementations, a policy (e.g., an access and mobility (AM) PCF policy) may be enhanced with time and location information, which may allow a network to determine a time and/or location at which a slice is available and then update an allowed NSSAI accordingly. By enhancing the policy with the time and location information, time-and-location-based URSPs may be simplified, and network guarantees may be provided that indicate that time and location use of the slice will be enforced. The allowed NSSAI may be influenced by the policy, which may include the time and location information. The policy may be a subscription policy (static) or a dynamic policy (e.g., provided by a PCF). Further, a validity time (or time window) and a location may be included as part of slice subscription information, which may enable an AMF to provide the allowed NSSAI based on the validity time and the location. As a result, by enabling the time and location information to be considered when determining the allowed NSSAI, an overall system performance may be improved.

In some implementations, the UE may determine to use location criteria and the validity time (or time window) in the URSP rules based on a UE implementation. The URSP rules may contain such information, but whether such information is being used by the UE may depend on the UE implementation, which may not be reliable. By allowing the allowed NSSAI to be influenced by the policy, a network implementation may support various use cases. For example, a use of the slice may be limited to a specific time or a specific location. The use of the slice may or may not be restricted to a particular time of day or location. The time of day and location at which the slice may be used may be dynamically changed. When no location information is present in a subscribed NSSAI, the AMF may always include the slice in the allowed NSSAI when requested by a user, the slice is supported by a gNB, and the user subscribes to the slice. Such use cases may improve the overall system performance. Further, while subscription data may be changed every time a change occurs in time or location, the subscription data, a unified data management (UDM), and/or a unified data repository (UDR) may not be designed for such dynamic changes, so allowing the allowed NSSAI to be influenced by the policy may be a more effective solution as compared to not allowing the NSSAI to be influenced by the policy.

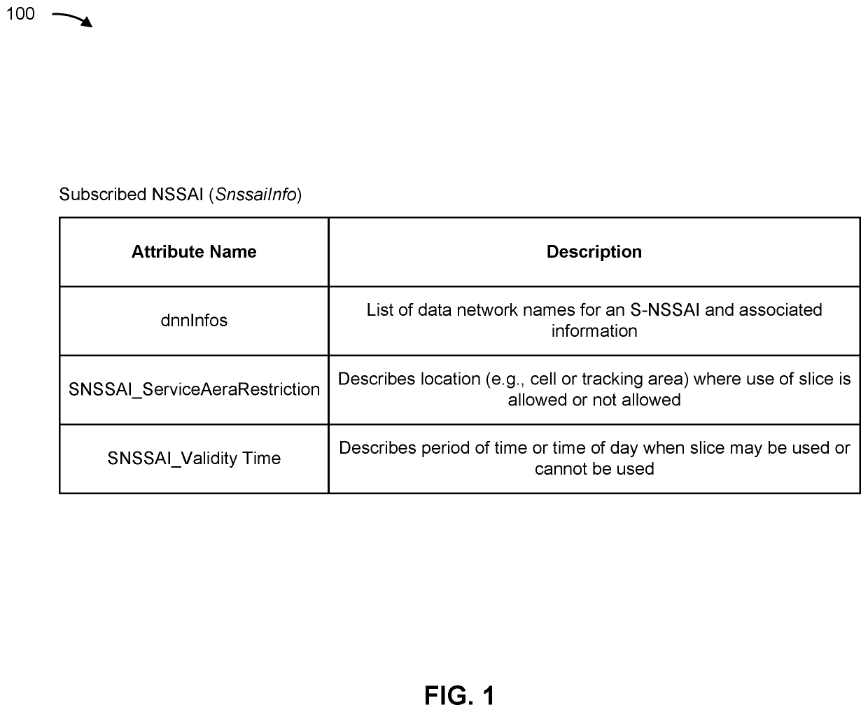

FIG. 1 is a diagram of an example 100 associated with subscribed NSSAI.

As shown in FIG. 1, subscribed NSSAI (SnssaiInfo) in subscription data and in AM data (or AM policy data) may be enhanced. For example, the subscribed NSSAI may include an attribute name of DNN information (dnnInfos), which may indicate a list of data network names for an S-NSSAI and associated information. The subscribed NSSAI may include an attribute name of subscribed NSSAI service area restriction (SNSSAI_ServiceAreaRestriction), which may describe a location (e.g., cell or tracking area) where use of a slice is allowed or not allowed. The subscribed NSSAI may include an attribute name of subscribed NSSAI validity time (SNSSAI_Validity Time), which may describe a period of time or a time of day during which the slice may be used or cannot be used. Thus, the subscription data (or subscriber data) may include one or more modified NSSAI information elements (IEs) to indicate the subscribed NSSAI service area restriction and the subscribed NSSAI validity time.

In some implementations, an AMF may take into account the subscribed NSSAI service area restriction for the slice when computing an allowed NSSAI. For example, a UE may subscribe to the slice, the UE may request the slice, and a gNB may support the slice. However, when the subscribed NSSAI service area restriction does not allow the slice on that specific gNB, the AMF may not include the slice in the allowed NSSAI. An AM-PCF may be able to modify the subscribed NSSAI service area restriction and/or the subscribed NSSAI validity time of the slice in the AM data based on policy. A subscribed NSSAI may be different than an NSSAI restricted by policy. The policy may be a static policy (e.g., part of the subscription data), or the policy may be a dynamic policy (e.g., part of the AM data). The static policy may be a subscription based policy. The dynamic policy may be created by the AM-PCF based on external triggers. A structure in the AM data may be created that describes the policies for the subscribed NSSAI service area restriction and the subscribed NSSAI validity time. In other words, a subscribed NSSAI modified by policy may be indicated in the AM data.

In some implementations, the AMF may compute a configured NSSAI as an intersection of a subscribed NSSAI and a non-restricted subscribed NSSAI modified by policy. The AMF may be influenced by policy based on different event triggers. The AMF may compute an allowed NSSAI based on an AMF functionality. The allowed NSSAI may be valid in a registration area. The allowed NSSAI may account for subscribed NSSAI restrictions (e.g., service area restriction and/or validity time restriction) based on policy. The UE may obtain, from the AMF, the allowed NSSAI as a response to a registration request or a configuration update. Further, the AMF may implement a timer to update the allowed NSSAI based on a validity time.

As indicated above, FIG. 1 is provided as an example. Other examples may differ from what is described with regard to FIG. 1.

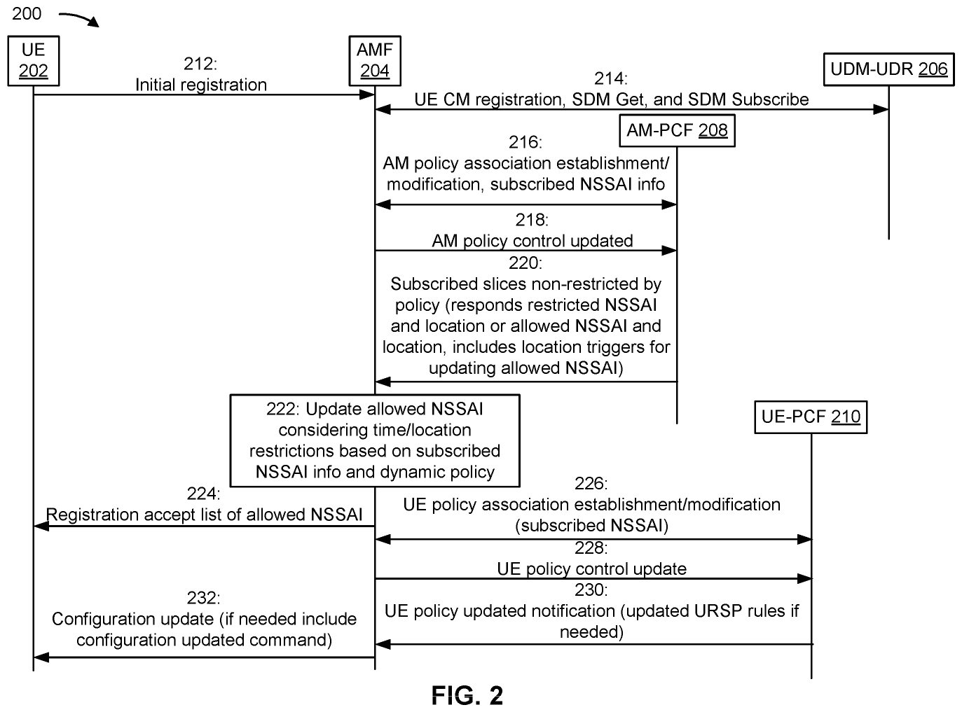

FIG. 2 is a diagram of an example 200 associated with determining an allowed NSSAI based on location information and time information. As shown in FIG. 2, example 200 includes a UE 202, an AMF 204, a UDM-UDR 206, an AM-PCF 208, and a UE-PCF 210.

As shown by reference number 212, the UE 202 may transmit an initial registration message to the AMF 204. The initial registration message may be a registration request. As shown by reference number 214, the AMF 204 and the UDM-UDR 206 may perform a UE context management (CM) registration, a subscriber data management (SDM) get procedure, and/or an SDM subscribe procedure. As shown by reference number 216, the AMF 204 and the AM-PCF 208 may perform an AM policy association establishment or modification, which may involve indicating subscribed NSSAI (e.g., as shown in FIG. 1). The AMF 204 may obtain the subscribed NSSAI based on the SDM get procedure. The subscribed NSSAI may indicate a subscribed NSSAI service area restriction and/or a subscribed NSSAI validity time. The AMF 204 may obtain a dynamic policy based on the AM policy association establishment or modification. As shown by reference number 218, the AMF 204 may transmit an AM policy control update message to the AM-PCF 208.

As shown by reference number 220, the AM-PCF 208 may transmit, to the AMF 204, an indication of subscribed slices that are non-restricted by policy. The AM-PCF 208 may indicate a restricted NSSAI and location, or an allowed NSSAI and location. In other words, the AM-PCF 208 may be able to modify the subscribed NSSAI service area restriction and/or a subscribed NSSAI validity time of a slice in AM data based on policy. The AM-PCF 208 may include location triggers for updating the allowed NSSAI. As shown by reference number 222, the AMF 204 may update the allowed NSSAI considering time/location restrictions based on the subscribed NSSAI (subscription data) and the dynamic policy. As shown by reference number 224, the AMF 204 may transmit, to the UE 202, a registration accept list of allowed NSSAI. In other words, the AMF 204 may indicate the allowed NSSAI to the UE 202, where the allowed NSSAI may be based on the time/location restrictions.

In some implementations, the AMF 204 may receive, from the AM-PCF 208, the subscribed NSSAI, which may indicate location information associated with a slice and time information associated with the slice. The location information may indicate a cell or a tracking area in which the slice is permitted to be used or is restricted from being used. The time information may indicate a period of time or a time of day in which the slice is permitted to be used or is restricted from being used. The AMF 204 may receive the subscribed NSSAI in subscription data. The subscription data may be associated with a static policy used for determining the allowed NSSAI. The AMF 204 may receive the subscribed NSSAI in AM policy data. The AM policy data may be associated with a dynamic policy used for determining the allowed NSSAI. The AMF 204 may determine the allowed NSSAI based on the location information and the time information. The AMF 204 may determine the allowed NSSAI based on the subscription data and/or the AM policy data. In some implementations, the AMF 204 may receive, from the AM-PCF 208, an indication of subscribed slices that are not restricted by a policy, restricted slices and associated locations and times, allowed slices and associated locations and times, and/or location triggers for updating the allowed NSSAI, and the AMF 204 may determine the allowed NSSAI based on the indication. The AMF 204 may transmit, to the UE 202, an indication of the allowed NSSAI. The AMF 204 may transmit the indication in response to a registration request or a configuration update. The allowed NSSAI may indicate a list of slices that the UE 202 is allowed to use. The UE 202 may be allowed to use the allowed NSSAI in a specific area and/or at a specific time, which may be based on a network implementation.

As shown by reference number 226, the AMF 204 and the UE-PCF 210 may perform a UE policy association establishment or modification, which may involve indicating the subscribed NSSAI. As shown by reference number 228, the AMF 204 may transmit a UE policy control update message to the UE-PCF 210. As shown by reference number 230, the UE-PCF 210 may transmit, to the AMF 204, a UE policy updated notification, which may indicate updated URSP rules if needed.

As shown by reference number 232, the AMF 204 may transmit, to the UE 202, a configuration update. The configuration update may include a configuration update command. The configuration update command may include configuration update indication parameters, which may indicate whether a network slicing subscription change has occurred, whether a network slice restriction policy has occurred, whether the UE 202 should acknowledge the UE configuration update command, and/or whether a registration procedure is requested.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

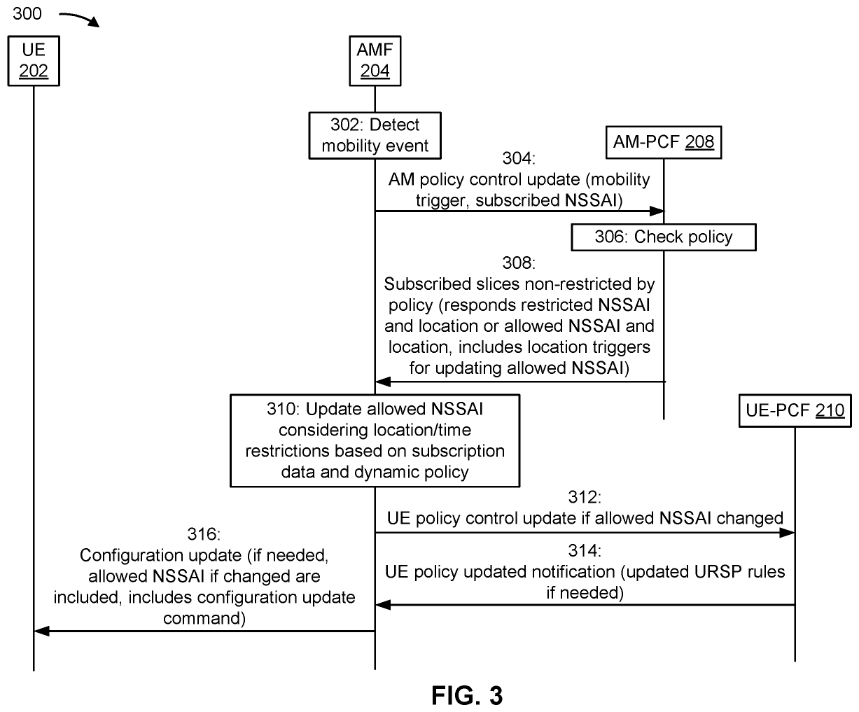

FIG. 3 is a diagram of an example 300 associated with determining an allowed NSSAI based on location information and time information. As shown in FIG. 3, example 300 includes a UE 202, an AMF 204, an AM-PCF 208, and a UE-PCF 210.

As shown by reference number 302, for a location update, the AMF 204 may detect a mobility event. The mobility event may be associated with the UE 202. As shown by reference number 304, the AMF 204 may transmit, to the AM-PCF 208, an AM policy control update message, which may indicate a mobility trigger and subscribed NSSAI (e.g., as shown in FIG. 1). As shown by reference number 306, the AM-PCF 208 may check a policy (e.g., a dynamic policy), which may be based on the mobility event and the AM policy control update message. The AM-PCF 208 may check whether the subscribed NSSAI is applicable to a current location, where the current location may be based on the mobility event. As shown by reference number 308, the AM-PCF 208 may transmit, to the AMF 204, an indication of subscribed slices that are non-restricted by the policy. The AM-PCF 208 may indicate a restricted NSSAI and location, or an allowed NSSAI and location. The AM-PCF 208 may include location triggers for updating the allowed NSSAI. As shown by reference number 310, the AMF 204 may update the allowed NSSAI considering time/location restrictions based on the subscribed NSSAI (subscription data) and the policy.

In some implementations, the AMF 204 may detect a mobility event associated with a location update. The AMF may transmit, to the AM-PCF 208, an AM policy control update message that indicates a mobility trigger associated with the mobility event and the subscribed NSSAI. The AMF 204 may receive, from the AM-PCF 208 and based on a check of a policy in response to the mobility event, an indication of subscribed slices that are not restricted by the policy, restricted slices and associated locations and times, allowed slices and associated locations and times, and/or location triggers for updating the allowed NSSAI, where the allowed NSSAI may be determined based on the indication.

As shown by reference number 312, the AMF 204 may transmit, to the UE-PCF 210, a UE policy control update message when the allowed NSSAI has changed. As shown by reference number 314, the UE-PCF 210 may transmit, to the AMF 204, a UE policy updated notification, which may indicate updated URSP rules if needed. As shown by reference number 316, the AMF 204 may transmit, to the UE 202, a configuration update. The configuration update may indicate the allowed NSSAI (if changed). The configuration update may include a configuration update command. The configuration update command may include configuration update indication parameters, which may indicate whether a network slicing subscription change has occurred, whether a network slice restriction policy has occurred, whether the UE 202 should acknowledge the UE configuration update command, and/or whether a registration procedure is requested.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

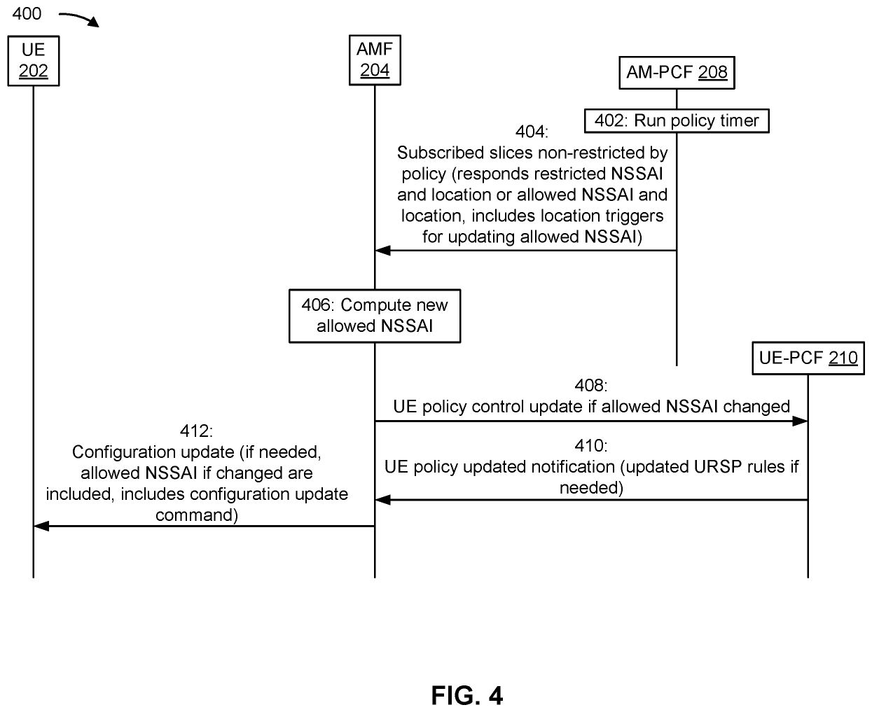

FIG. 4 is a diagram of an example 400 associated with determining an allowed NSSAI based on location information and time information. As shown in FIG. 4, example 400 includes a UE 202, an AMF 204, an AM-PCF 208, and a UE-PCF 210.

As shown by reference number 402, for a timer event, the AM-PCF 208 may run a policy timer, which may correspond to a particular time of day. The AM-PCF 208 may detect the timer event based on the policy timer. For example, an expiry of the policy timer may cause an allowed NSSAI to be updated. As shown by reference number 404, the AM-PCF 208 may transmit, to the AMF 204, an indication of subscribed slices that are non-restricted by policy. The AM-PCF 208 may indicate a restricted NSSAI and location, or an allowed NSSAI and location. The AM-PCF 208 may include location triggers for updating the allowed NSSAI. As shown by reference number 406, the AMF 204 may compute a new allowed NSSAI, which may be based on the indication received from the AM-PCF 208. The new allowed NSSAI may be in response to the policy timer (or the timer event). For example, the new allowed NSSAI may be determined in response to an expiry of the policy timer.

As shown by reference number 408, the AMF 204 may transmit, to the UE-PCF 210, a UE policy control update message when the allowed NSSAI has changed. As shown by reference number 410, the UE-PCF 210 may transmit, to the AMF 204, a UE policy updated notification, which may indicate updated URSP rules if needed. As shown by reference number 412, the AMF 204 may transmit, to the UE 202, a configuration update. The configuration update may indicate the allowed NSSAI (if changed). The configuration update may include a configuration update command.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

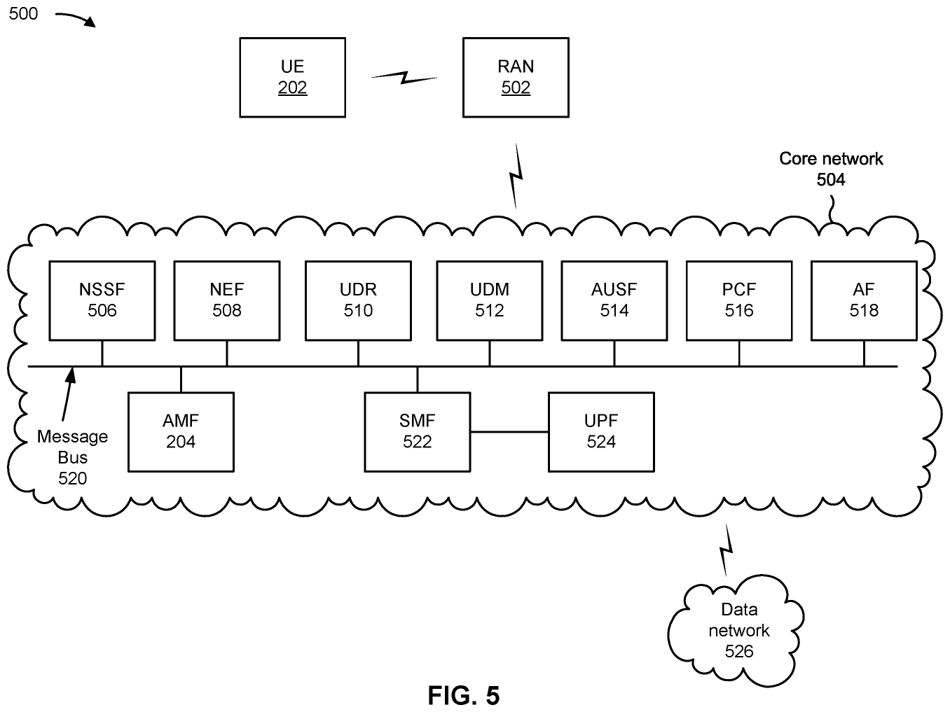

FIG. 5 is a diagram of an example environment 500 in which systems and/or methods described herein may be implemented. As shown in FIG. 5, example environment 500 may include a UE 202, a RAN 502, a core network 504, and a data network 526. Devices and/or networks of example environment 500 may interconnect via wired connections, wireless connections, or a combination of wired and wireless connections.

The UE 202 may include one or more devices capable of receiving, generating, storing, processing, and/or providing information, such as information described herein. For example, the UE 202 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 502 may support, for example, a cellular radio access technology (RAT). The RAN 502 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 202. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 502 may transfer traffic between the UE 202 (e.g., using a cellular RAT), one or more base stations (e.g., using a wireless interface or a backhaul interface, such as a wired backhaul interface), and/or the core network 504. The RAN 502 may provide one or more cells that cover geographic areas.

In some implementations, the RAN 502 may perform scheduling and/or resource management for the UE 202 covered by the RAN 502 (e.g., the UE 202 covered by a cell provided by the RAN 502). In some implementations, the RAN 502 may be controlled or coordinated by a network controller, which may perform load balancing, network-level configuration, and/or other operations. The network controller may communicate with the RAN 502 via a wireless or wireline backhaul. In some implementations, the RAN 502 may include a network controller, a self-organizing network (SON) module or component, or a similar module or component. In other words, the RAN 502 may perform network control, scheduling, and/or network management functions (e.g., for uplink, downlink, and/or sidelink communications of the UE 202 covered by the RAN 502).

In some implementations, the core network 504 may include an example functional architecture in which systems and/or methods described herein may be implemented. For example, the core network 504 may include an example architecture of a fifth generation (5G) next generation (NG) core network included in a 5G wireless telecommunications system. While the example architecture of the core network 504 shown in FIG. 5 may be an example of a service-based architecture, in some implementations, the core network 504 may be implemented as a reference-point architecture and/or a 5G core network, among other examples.

As shown in FIG. 5, the core network 504 includes a number of functional elements. The functional elements may include, for example, a network slice selection function (NSSF) 506, a network exposure function (NEF) 508, a UDR 510, a UDM 512, an authentication server function (AUSF) 514, a policy control function (PCF) 516, an application function (AF) 518, an AMF 204, a session management function (SMF) 522, and/or a user plane function (UPF) 524. These functional elements may be communicatively connected via a message bus 520. Each of the functional elements shown in FIG. 5 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 506 may include one or more devices that select network slice instances for the UE 202. The NSSF 506 may allow an operator to deploy multiple substantially independent end-to-end networks potentially with the same infrastructure. In some implementations, each slice may be customized for different services. The NEF 508 may include one or more devices that support exposure of capabilities and/or events in the wireless telecommunications system to help other entities in the wireless telecommunications system discover network services.

The UDR 510 may include one or more devices that provide a converged repository, which may be used by network functions to store data. For example, a converged repository of subscriber information may be used to service a number of network functions. The UDM 512 may include one or more devices to store user data and profiles in the wireless telecommunications system. The UDM 512 may generate authentication vectors, perform user identification handling, perform subscription management, and perform other various functions. The AUSF 514 may include one or more devices that act as an authentication server and support the process of authenticating the UE 202 in the wireless telecommunications system.

The PCF 516 may include one or more devices that provide a policy framework that incorporates network slicing, roaming, packet processing, and/or mobility management, among other examples. The AF 518 may include one or more devices that support application influence on traffic routing, access to the NEF 508, and/or policy control, among other examples. The AMF 204 may include one or more devices that act as a termination point for non-access stratum (NAS) signaling and/or mobility management, among other examples. The SMF 522 may include one or more devices that support the establishment, modification, and release of communication sessions in the wireless telecommunications system. For example, the SMF 522 may configure traffic steering policies at the UPF 524 and/or may enforce UE internet protocol (IP) address allocation and policies, among other examples. The UPF 524 may include one or more devices that serve as an anchor point for intra-RAT and/or inter-RAT mobility. The UPF 524 may apply rules to packets, such as rules pertaining to packet routing, traffic reporting, and/or handling user plane quality of service (QOS), among other examples. The message bus 520 may represent a communication structure for communication among the functional elements. In other words, the message bus 520 may permit communication between two or more functional elements.

The data network 526 may include one or more wired and/or wireless data networks. For example, the data network 526 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of example environment 500 may perform one or more functions described as being performed by another set of devices of example environment 500.

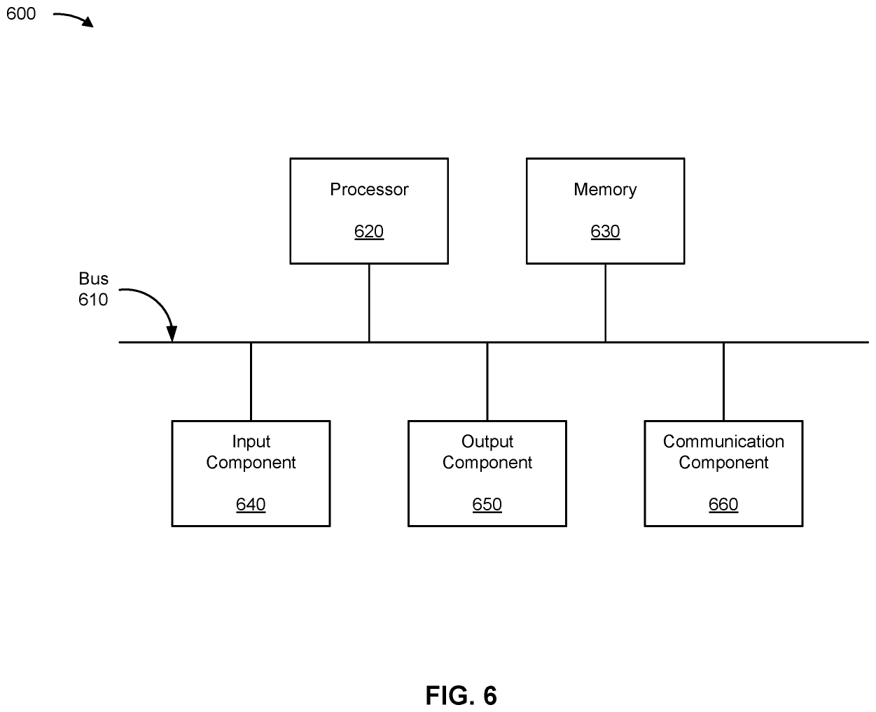

FIG. 6 is a diagram of example components of a device 600 associated with determining an allowed NSSAI based on location information and time information. The device 600 may correspond to an AMF (e.g., AMF 204). In some implementations, the AMF may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

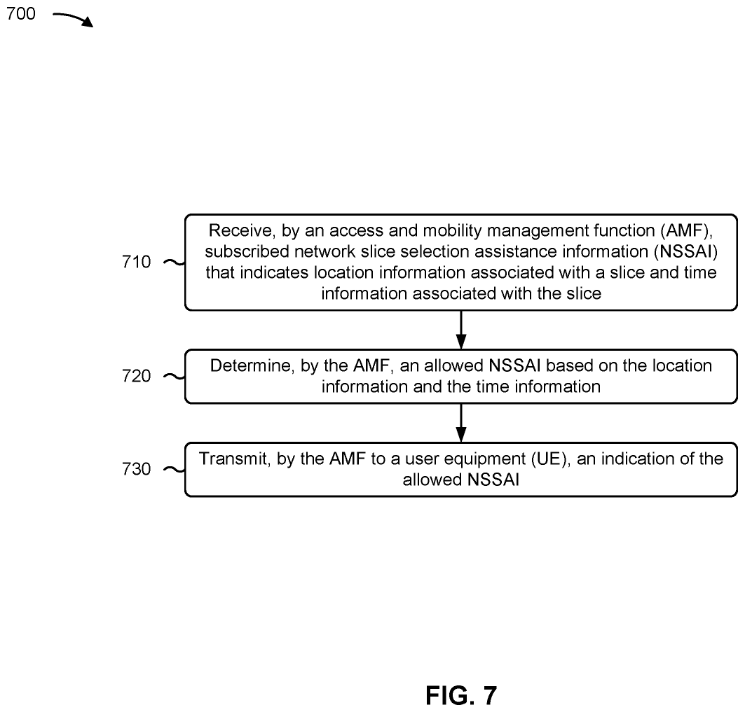

FIG. 7 is a flowchart of an example process 700 associated with determining an allowed NSSAI based on location information and time information. In some implementations, one or more process blocks of FIG. 7 may be performed by an AMF (e.g., AMF 204). In some implementations, one or more process blocks of FIG. 7 may be performed by another device or a group of devices separate from or including the AMF, such as a UE (e.g., UE 202), a UDM-UDR (e.g., UDM-UDR 206), an AM-PCF (e.g., AM-PCF 208), or a UE-PCF (e.g., UE-PCF 210). Additionally, or alternatively, one or more process blocks of FIG. 7 may be performed by one or more components of device 600, such as processor 620, memory 630, input component 640, output component 650, and/or communication component 660.

As shown in FIG. 7, process 700 may include receiving, by the AMF and from an AM-PCF, subscribed NSSAI that indicates location information associated with a slice and time information associated with the slice (block 710). The location information may indicate a cell or a tracking area in which the slice is permitted to be used or is restricted from being used. The time information may indicate a period of time or a time of day in which the slice is permitted to be used or is restricted from being used.

The AMF may receive the subscribed NSSAI in subscription data. The subscription data may be associated with a static policy used for determining the allowed NSSAI. The AMF may receive the subscribed NSSAI in AM policy data. The AM policy data may be associated with a dynamic policy used for determining the allowed NSSAI.

As shown in FIG. 7, process 700 may include determining, by the AMF, an allowed NSSAI based on the location information and the time information (block 720). The AMF may determine the allowed NSSAI based on the subscription data and/or the AM policy data. In some implementations, the AMF may receive, from the AM-PCF, an indication of subscribed slices that are not restricted by a policy, restricted slices and associated locations and times, allowed slices and associated locations and times, and/or location triggers for updating the allowed NSSAI. The AMF may determine the allowed NSSAI based on the indication.

As shown in FIG. 7, process 700 may include transmitting, by the AMF to a UE, an indication of the allowed NSSAI (block 730). The AMF may transmit the indication in response to a registration request or a configuration update. The allowed NSSAI may indicate a list of slices that the UE is allowed to use. The UE may be allowed to use the allowed NSSAI in a specific area and/or at a specific time, which may be based on a network implementation.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by an access and mobility management function (AMF), subscribed network slice selection assistance information (NSSAI) that indicates location information associated with a slice and time information associated with the slice;
determining, by the AMF, an allowed NSSAI based on the location information and the time information; and
transmitting, by the AMF to a user equipment (UE), an indication of the allowed NSSAI.

2. The method of claim 1, wherein the subscribed NSSAI is received in subscription data, and the subscription data is associated with a static policy used for determining the allowed NSSAI.

3. The method of claim 1, wherein the subscribed NSSAI is received in access and mobility (AM) policy data, and the AM policy data is associated with a dynamic policy used for determining the allowed NSSAI.

4. The method of claim 1, wherein the subscribed NSSAI is received from an access and mobility policy control function (AM-PCF).

5. The method of claim 1, further comprising:
receiving, by the AMF, an indication of one or more of: subscribed slices that are not restricted by a policy, restricted slices and associated locations and times, allowed slices and associated locations and times, and location triggers for updating the allowed NSSAI, wherein the allowed NSSAI is determined based on the indication.

6. The method of claim 1, wherein the location information indicates a cell or a tracking area in which the slice is permitted to be used or is restricted from being used.

7. The method of claim 1, wherein the time information indicates a period of time or a time of day in which the slice is permitted to be used or is restricted from being used.

8. The method of claim 1, wherein the indication of the allowed NSSAI is transmitted in response to a registration request or a configuration update.

9. The method of claim 1, further comprising:
detecting, by the AMF, a mobility event associated with a location update;
transmitting, by the AMF, an access and mobility (AM) policy control update message that indicates a mobility trigger associated with the mobility event and the subscribed NSSAI; and
receiving, by the AMF and based on a check of a policy in response to the mobility event, an indication of one or more of: subscribed slices that are not restricted by the policy, restricted slices and associated locations and times, allowed slices and associated locations and times, and location triggers for updating the allowed NSSAI, wherein the allowed NSSAI is determined based on the indication.

10. The method of claim 1, further comprising:
transmitting, by the AMF and to a user equipment (UE), a configuration update command indicating that a network slice restriction policy has occurred.

11. The method of claim 1, wherein the allowed NSSAI is determined in response to an expiry of a policy timer.

12. A device, comprising:
one or more processors configured to:
receive subscribed network slice selection assistance information (NSSAI) that indicates location information associated with a slice and time information associated with the slice; and
transmit, to a user equipment (UE), an indication of an allowed NSSAI, wherein the allowed NSSAI is based on the location information and the time information.

13. The device of claim 12, wherein the subscribed NSSAI is received in subscription data, and the subscription data is associated with a static policy used for determining the allowed NSSAI.

14. The device of claim 12, wherein the subscribed NSSAI is received in access and mobility (AM) policy data, and the AM policy data is associated with a dynamic policy used for determining the allowed NSSAI.

15. The device of claim 12, wherein the one or more processors are further configured to:
receive an indication of one or more of: subscribed slices that are not restricted by a policy, restricted slices and associated locations and times, allowed slices and associated locations and times, and location triggers for updating the allowed NSSAI, wherein the allowed NSSAI is determined based on the indication.

16. The device of claim 12, wherein:
the location information indicates a cell or a tracking area in which the slice is permitted to be used or is restricted from being used; or
the time information indicates a period of time or a time of day in which the slice is permitted to be used or is restricted from being used.

17. A non-transitory computer-readable medium storing a set of instructions, the set of instructions comprising:
one or more instructions that, when executed by one or more processors of a device, cause the device to:
receive, from an access and mobility policy control function (AM-PCF), subscribed network slice selection assistance information (NSSAI) that indicates one or more of location information associated with a slice or time information associated with the slice;
determine an allowed NSSAI based on one or more of the location information or the time information; and
transmit, to a user equipment (UE), an indication of the allowed NSSAI.

18. The non-transitory computer-readable medium of claim 17, wherein:
the subscribed NSSAI is received in subscription data, and the subscription data is associated with a static policy used for determining the allowed NSSAI; or
the subscribed NSSAI is received in access and mobility (AM) policy data, and the AM policy data is associated with a dynamic policy used for determining the allowed NSSAI.

19. The non-transitory computer-readable medium of claim 17, wherein the one or more instructions, when executed by the one or more processors, further cause the device to:
receive an indication of one or more of: subscribed slices that are not restricted by a policy, restricted slices and associated locations and times, allowed slices and associated locations and times, and location triggers for updating the allowed NSSAI, wherein the allowed NSSAI is determined based on the indication.

20. The non-transitory computer-readable medium of claim 17, wherein:
the location information indicates a cell or a tracking area in which the slice is permitted to be used or is restricted from being used; or
the time information indicates a period of time or a time of day in which the slice is permitted to be used or is restricted from being used.
